(19) United States
(12) Patent Application Publication
(10) Pub. No.: US 2018/0060985 A1
(43) Pub. Date: Mar. 1, 2018

(54) ONLINE 24/7 VIRTUAL COACHING PLATFORM

(71) Applicant: Mario Tenerelli Neto, Santana de Parnaiba (BR)

(72) Inventor: Mario Tenerelli Neto, Santana de Parnaiba (BR)

(21) Appl. No.: 15/412,165

(22) Filed: Jan. 23, 2017

Related U.S. Application Data
(60) Provisional application No. 62/378,293, filed on Aug. 23, 2016.

(51) Int. Cl. G06Q 50/20; G06Q 10/06; G06Q 30/02; G06Q 10/10

(52) U.S. Cl. CPC G06Q 50/2057; G06Q 10/1095; G06Q 30/0204; G06Q 10/063112

(57) ABSTRACT

An online 24/7 virtual coaching platform is provided. The coaching platform includes remotely coupling a plurality of coaches to a computer; providing a database for the computer, wherein the computer is adapted to retrievably store a credential of each of the plurality of coaches, wherein the computer is adapted to identify an availability of each of the plurality of coaches; providing a preference selection functionality for the computer, wherein the computer is adapted to prompt a user for a selection from a plurality of market segments, wherein the plurality of market segments includes a list of coaching areas and a list of expertise levels; and in response to receiving the selection, determining at the computer an associated coach from the plurality of coaches based in part on the selection and the credential of the associated coach.

### CROSS-REFERENCE TO RELATED APPLICATION

This application claims the benefit of priority of U.S. provisional application No. 62/378,293, filed 23 Aug. 2016, the contents of which are herein incorporated by reference.

### BACKGROUND OF THE INVENTION

The present invention relates to coaching and, more particularly, an online 24/7 virtual coaching platform.

At present, navigating the demands of their professional practice makes coaching a must for many professionals. And preferably immediate coaching instead of waiting for pre-scheduled traditional coaching sessions. Currently, coaching services are provided either in person or remotely only by phone or video, but however only at pre-approved scheduled times, tending to inhibit professionals looking for coaching services, as well as inhibiting those providing coaching services. This failure to provide 24/7 global online coaching services that leverages ubiquitous smart device technologies and coaches of the professionals' preference also frustrates the participation of recognized former industry leaders (in other words, retirees with a wealth of experience) as coaches.

Many professionals need some sort of coaching for many issues that arise unexpectedly in their careers, and most of the coaches available are pre-indicated by employees' companies (through corporate coaching programs) for conventional in-person coaching or remote phone coaching consisting of only phone calls and videos.

Furthermore, current corporate coaching service providers commonly do not allow the professional to choose a coach of his/her preference; rather, unknown pre-selected coaches of possibly unrelated areas of expertise are in essence forced upon the professionals. Facts are that professionals prefer and would feel much more comfortable talking and expressing their feelings and personal issues utilizing a coach of their choice from an area of expertise they need or selected since it has been said, “efficacy of the coaching is a function of the state of mind of the professional receiving the coaching”. Moreover, corporate coaches tend to also request a final discussion where the employee's supervisor participates, wherein employees fear final reports will be sent to their respective companies, thereby undermining the true independence a coach needs to render their advice.

As can be seen, there is a need for globalcoach.com, 24/7 an online virtual coaching platform enabling recognized former industry leaders to coach professionals immediately through smart device technology across the world on an on-demand basis, where professionals are enabled to select a coach who has a proven track record and is experience in the market segment of the professional user.

### SUMMARY OF THE INVENTION

In one aspect of the present invention, a online 24/7 virtual coaching platform includes remotely coupling a plurality of coaches to a computer; providing a database for the computer, wherein the computer is adapted to retrievably store a credential of each of the plurality of coaches; providing a coach availability modality for the computer, wherein the computer is adapted to identify an availability of each of the plurality of coaches; the computer supported by electronic communication functionality; providing a preference selection functionality for the computer, wherein the computer is adapted to prompt a user for a selection from a plurality of market segments, wherein the plurality of market segments includes a list of coaching areas and a list of expertise levels; in response to receiving said selection, determining at said computer an associated coach from the plurality of coaches based in part on said selection and the credential of said associated coach; and the coach availability modality providing the user through the computer with the availability of the associated coach.

In another aspect of the present invention, the online 24/7 virtual coaching platform includes remotely coupling a plurality of coaches to a computer; providing a database for the computer, wherein the computer is adapted to retrievably store a credential of each of the plurality of coaches, wherein the credential includes at least one coaching area and an expertise level for each coaching area, wherein the coaching areas include professional career, sports, politics and scholastic areas;

providing a coach availability modality for the computer, wherein the computer is adapted to identify an availability of each of the plurality of coaches; the computer supported by electronic communication functionality, wherein the electronic communication includes instant messaging, email, text, instant chat, phone and video communications; providing a preference selection functionality for the computer, wherein the computer is adapted to prompt a user for a selection from a plurality of market segments, wherein the plurality of market segments includes a list of coaching areas, a list of segment payers, and a list of expertise levels, wherein the list of segment payers includes independent payer and corporate payers; in response to receiving said selection, determining at said computer an associated coach from the plurality of coaches based in part on said selection and the credential of said associated coach; the coach availability modality providing the user through the computer with the availability of the associated coach; and providing a documentation modality for the computer, wherein the computer is adapted to document and retrievably store records of each coaching session between the user and each of the plurality of the coaches that agrees thereto.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the present invention.

Broadly, an embodiment of the present invention provides globalcoach.com, an online 24/7 virtual coaching platform enabling recognized former industry leaders to coach professionals through smart device technology throughout the world on a 24/7, on-demand basis, whereby the online virtual coaching platform may provide independent consulting to support development of professionals so that, “who you choose, what subject, what day and what time and what form will be up to you”. The online virtual coaching platform interconnects users with a network of coaches, thereby enabling the following functionalities: an online payment mechanism; a satisfaction ratings mechanism for users to rate each coach, a database of coach data providing information about, but not limited to, each coach's area of expertise, credentials, industry knowledge, and availability, and preference selection functionality, adapted for professional-users to transparently select coaches from the network of coaches.

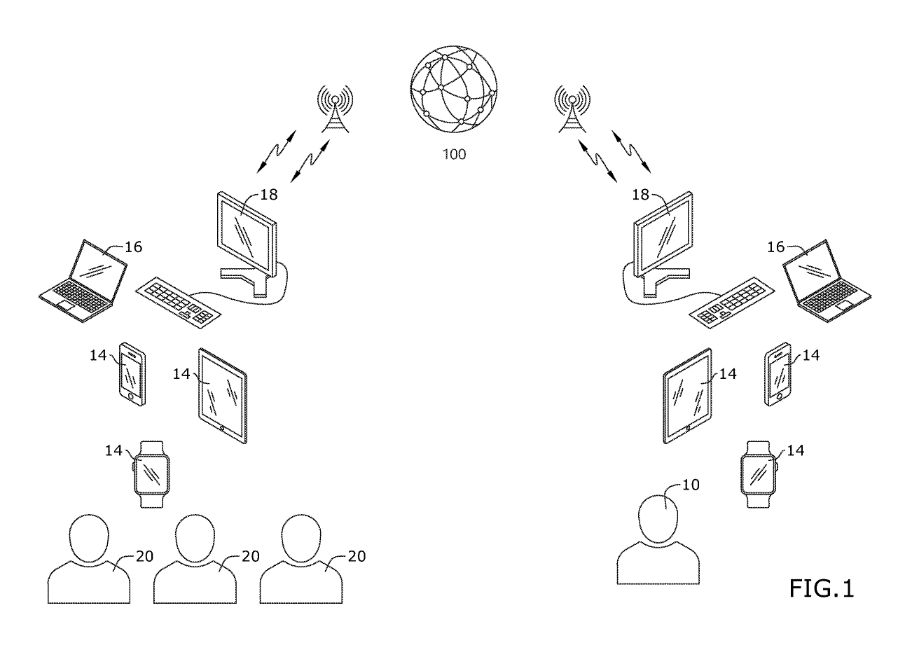

Referring now to FIG. 1, the present invention may include at least one computer with a user interface. The computer may include at least one processing unit coupled a form of memory, and so the computer may include, but not be limited to, a desktop 18, laptop 16, and smart device 14, such as, a tablet and smart phones. The computer includes a program product including a machine-readable program code for causing, when executed, the computer to perform steps. The program product may include software which may either be loaded onto the computer or accessed by the computer. The loaded software may include an application on the computer. The software may be accessed by the computer using a web browser. The computer may access the software via the web browser using the internet, extranet, intranet, host server, internet cloud and the like.

The present invention may include an online virtual coaching platform 100 enabling, through the computer and associated software application(s), 24/7 online global access to a network of coaches selected by the professional they will coach. The coaching platform 100 may provide coaching services through a website accessible through the computer, including video, phone, text, instant messaging, instant chatting, emailing, exportable documents, as well as phone and the like. The coaching platform 100 interconnects users 10 with a network of coaches 20, thereby enabling the following functionalities: an online payment mechanism; a satisfaction ratings mechanism for users to rate each coach 20, a database of coach data providing information about, but not limited to, each coach's area of expertise, credentials, industry knowledge, and availability, and preference selection functionality, adapted for professional-users to transparently select coaches from the network of coaches.

The online payment mechanism, may enable pay-as-you go services through credit cards or other forms of electronic payment, whereby users 10 can buy a certain time for coaching services. The coaching platform 100 may be adapted to provide an account coach-meter, showing the level of available credit for usage under the pay as you go controlled payment mechanism. Payment through the online payment mechanism may provide a user 10 access the coaching platform 100 and its network of coaches 20, including renowned experienced coaches with expertise in the areas and industries desired by the professional-user 10. Thereby, the coaching platform 100 allows former industry leaders and well-known personalities to become available for coaching, enabling the selection of a coach 20 therefrom, while avoiding traditional pre-scheduling timing and waiting.

The preference selection functionality may prompt the user 10 to select from a list of market segments covered by globalcoach.com/coaching platform 100.

The market segment may include (a) areas of coaching such as professional career themes, sports, politics, students and other areas of coaching; (b) segment payers, such as independent professionals, corporate payers or the like; (c) level of expertise, such as former industry leaders and coaching professionals; and (d) language preferences.

The coaching platform 100 may provide a coach availability modality adapted for spot questions or sessions on-demand where professionals need immediate advisory for unexpected themes such as a meeting, a negotiation, a personal work conflict, a rough debate with a supervisor, with a work colleague with a peer among others. The coach availability modality may be supported by computer functionality facilitating instant-messaging and other forms of electronic communication, wherein a user can email, text or instant chat with your coach through the coaching platform 100. Likewise, the coach availability modality may be supported by instant-phone coaching and video-coaching, wherein the user 10 can talk through a phone or web video, respectively, to their selected coach through the coaching platform 100.

Selection of a coach 20 may also be based on differentiated rates, user-satisfaction ratings, a database of each coach's country of location and industry/market segment experiences and expertise; and availability of web tracking, wherein web tracking enables documentation and keeping historic records of all coaching sessions under very strict secrecy agreements depending on a documentation modality mentees and coaches agree to, and wherein professionals and coaches, as per coaches' duly authorization, can write down notes and history of coaching sessions under strict secrecy agreements. The database may allow coaches to screen for possible users 10 matching their areas of expertise, and employee areas in need of coaching.

Additionally, the present invention could be used in various industry segments, such as, but not restricted to: professional career development, sports, politics, student education, entrepreneurship, running a business, Board of Directors Leadership, and others.

The computer or smart device-based data processing system and method described above is for purposes of example only, and may be implemented in any type of computer system or programming or processing environment, or in a computer program, alone or in conjunction with hardware and smart devices. The present invention may also be implemented in software stored on a computer-readable medium and executed as a computer program or through a smart device on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer or smart device language, program, or computer. It is further contemplated that the present invention may be run on a stand-alone computer system, or may be run from a server computer system that can be accessed by a plurality of client computer or smart device systems interconnected over a global intranet network, or that is accessible to clients over the Internet. In addition, many embodiments of the present invention have application to a wide range of industries.

To the extent the present application discloses a system, the method implemented by that system, as well as software stored on a computer or smart device readable medium and executed as a computer program to perform the method on a general purpose or special purpose computer, are within the scope of the present invention.

Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A computerized method for providing on-demand coaching services, comprising:
remotely coupling a plurality of coaches to a computer;
providing a database for the computer, wherein the computer is configured to retrievably store a credential of each of the plurality of coaches;
providing a coach availability modality for the computer, wherein the computer is configured to identify an availability of each of the plurality of coaches;
the computer supported by electronic communication functionality;
providing a preference selection functionality for the computer, wherein the computer is configured to prompt a user for a selection from a plurality of market segments, wherein the plurality of market segments comprises a list of coaching areas and a list of expertise levels;
in response to receiving said selection, determining at said computer an associated coach from the plurality of coaches based in part on said selection and the credential of said associated coach; and
the coach availability modality providing the user through the computer with the availability of the associated coach.

2. The method of claim 1, wherein the plurality of market segments comprises a list of segment payers including independent payer and corporate payers.

3. The method of claim 1, wherein the electronic communication includes instant messaging, email, text, instant chat, phone and video communications.

4. The method of claim 1, wherein the credential comprises at least one coaching area and an expertise level for each coaching area.

5. The method of claim 1, wherein the coaching areas include professional career, sports, politics and scholastic areas.

6. The method of claim 1, further providing a documentation modality for the computer, wherein the computer is configured to document and retrievably store records of each coaching session between the user and each of the plurality of the coaches that agrees thereto.

7. A computerized method for providing on-demand coaching services, comprising:
remotely coupling a plurality of coaches to a computer;
providing a database for the computer, wherein the computer is configured to retrievably store a credential of each of the plurality of coaches, wherein the credential comprises at least one coaching area and an expertise level for each coaching area, wherein the coaching areas include professional career, sports, politics and scholastic areas;
providing a coach availability modality for the computer, wherein the computer is configured to identify an availability of each of the plurality of coaches;
the computer supported by electronic communication functionality, wherein the electronic communication includes instant messaging, email, text, instant chat, phone and video communications;
providing a preference selection functionality for the computer, wherein the computer is configured to prompt a user for a selection from a plurality of market segments, wherein the plurality of market segments comprises a list of coaching areas, a list of segment payers, and a list of expertise levels, wherein the list of segment payers includes independent payer and corporate payers;
in response to receiving said selection, determining at said computer an associated coach from the plurality of coaches based in part on said selection and the credential of said associated coach;
the coach availability modality providing the user through the computer with the availability of the associated coach; and
providing a documentation modality for the computer, wherein the computer is configured to document and retrievably store records of each coaching session between the user and each of the plurality of the coaches that agrees thereto.
